(19) United States
(12) Patent Application Publication
(10) Pub. No.: US 2014/0158550 A1
(43) Pub. Date: Jun. 12, 2014

(54) Method for Water Treatment Coupling Electrocoagulation and Sonic Energy

(71) Applicant: Baker Hughes Incorporated, Houston, TX (US)

(72) Inventors: Kushal Seth, Houston, TX (US); Evan Kent Dawson, Houston, TX (US)

(73) Assignee: Baker Hughes Incorporated, Houston, TX (US)

(21) Appl. No.: 13/937,614

(22) Filed: Jul. 9, 2013

Related U.S. Application Data
(60) Provisional application No. 61/669,193, filed on Jul. 9, 2012.

(51) Int. Cl. C02F 1/463; C02F 1/465

(52) U.S. Cl. CPC C02F 1/463; C02F 1/465
USPC 205/751

(57) ABSTRACT

The onset of flocculation of undesirable chemicals within produced water is accelerated by treatment of the produced water with electrocoagulation and sonication. The sonoelectrochemical method described herein provides a faster and more dynamic means to reduce the requisite retention time for separation of flocculants.

This application claims the benefit of U.S. patent application Ser. No. 61/669,193, filed on Jul. 9, 2012, herein incorporated by reference.

### FIELD OF THE INVENTION

The invention relates to a method for treating produced water using both electrocoagulation and sonication.

### BACKGROUND OF THE INVENTION

In addition to hydrocarbons, a large quantity of produced water is generated during oil and gas production operations. Produced water normally includes natural contaminants originating from the subsurface environment, such as hydrocarbons from the oil- or gas-bearing strata and inorganic salts. In addition, produced water contains chemicals introduced into well treatment fluids such as polymers, breakers, friction reducers, lubricants, acids and caustics; bactericides, defoamers; emulsifiers, filtrate reducers, shale control inhibitors, etc. Such undesirable materials may be removed before produced water may be reused for oilfield operations.

In the past, various methods have been explored to treat produced water. However, because of the wide range of contaminants and the quality of produced water originating from different sources, cost effective treatment systems have not been successful. For example, one method which has been examined is reverse osmosis. This method, however, has not been proven to be effective since it is typically fouled by even trace amounts of friction reduction agents, such as polyacrylamides, and oils. The presence of such materials further contribute to reclaimed produced water being unsuitable as hydraulic fracturing fluids since they inhibit the formation of viscous gels from viscosifying polymers.

More recently, electrocoagulation has been reported to be useful in the removal of a large range of undesirable materials from produced water. In electrocoagulation, an electric current is applied to electrodes through the conductive wastewater. Anodes made of iron or aluminum are consumed to produce positively charged ions in the treatment stream to attract the negatively charged contaminant particles and thereby initiate flocculation, resulting in increased particle size.

Also, during electrocoagulation, hydrolysis of produced water renders oxygen, hydrogen, and hydroxyl ions. As water containing colloidal particulates, oils, metals, or other contaminants move between the electrodes, ionization, electrolysis, oxidation, precipitation, and free radical formation may occur. This alters the physical and chemical properties of the contaminants which, in turn, causes coagulation and flocculation of the contaminants.

Flocculated contaminants may be removed from the treatment stream. Preferred methods for removal of flocculated contaminants include sinking, flotation and filtration.

It is not uncommon, however, for fouling of the electrodes to occur from the build-up of non-reactive material on the surface of the electrodes. This results in an uneven degree of activity over the electrodes and often leads to plugging and blocking of the treatment flow, the build-up of treatment gases, and the pitting, gouging, and uneven wear of electrode plate surfaces. The likelihood of these occurrences increases with increased time duration for the formation of flocculated contaminants. Uncontrolled fouling of the electrodes is a major cause of failure of electrocoagulation cells. The high level of cell maintenance has thus limited the commercial success and the ability to treat produced water on a commercial scale.

Lengthy retention time for contaminant flocculation is also highly undesirable on-the-fly. It might take up to a day for the flocculated material to settle, thus increasing the cost of operation and the footprint of the treatment plan.

There is a need, therefore, for methods to reduce the retention time for flocculant formation.

Further, there is a need for an electrocoagulation process for removing undesirable chemicals from produced water that is energy efficient and cost-effective and which minimizes the effect of fouling of the electrodes.

### SUMMARY OF THE INVENTION

A method of decreasing the retention time in the formation of flocculants during the treatment of produced water by electrocoagulation consists of coupling electrocoagulation with sonic energy.

The ultrasonic waves may be generated from a sonicator submerged in the electrocoagulation cell.

Coupling electrocoagulation with sonic energy assists in the removal and degradation of scales and minerals from the electrodes of the electrocoagulation cell. This reduced electrode fouling and increased the operational life of the electrodes.

The sonicator may further be in a separate staging container from the electrocoagulation cell, such as a storage tank or frac tank. After the produced water is subjected to electrocoagulation, the treated water is then transferred into the separate staging container for sonication. Reclaimed water is then retrieved from the separate staging container.

The method described herein provides for increased aggregation of flocculants during electrocoagulation and enhanced mass transport of undesirable contaminants through sonication. Retention time for flocculation is thereby reduced. In addition, due to the enhanced mass transport, the method described herein reduces the amount of time required for settling of flocculants prior to the separation of flocculants from the aqueous medium. Reduced settling time is further aided by the increased size of flocculants attributable to the coupling of ultrasonic waves with electrocoagulation.

The ultrasonic waves also cause the formation of microbubbles which accelerate the oxidation and destruction of aromatic compounds in the produced water.

### BRIEF DESCRIPTION OF THE DRAWINGS

In order to more fully understand the drawings referred to in the detailed description of the present invention, a brief description of each drawing is presented, in which:

FIG. 1 depicts an embodiment wherein a sonication device is submerged in an electrocoagulation cell.

FIG. 2 depicts an embodiment wherein a sonication device may be submerged in a staging container separate from the electrocoagulation cell.

### DETAILED DESCRIPTION OF THE PREFERRED EMBODIMENTS

Produced water is processed by the combination of electrocoagulation and sonic energy. Untreated produced water contains fine suspended particulates. While electrocoagulation, by itself, increases the particle size of the particulates, the combination of electrocoagulation and sonic energy facilitates the removal of particulates by rendering a top layer of lighter solids and/or a bottom layer of heavy solids.

By subjecting produced water to electrocoagulation and ultrasonic waves, the retention time is decreased. Typically, the retention time, upon the integration of electrocoagulation and sonic energy, is between from about 1 to about 5 hours.

The term “retention time” as used herein refers to the amount of time that produced water is subjected to treatment until the start of flocculation of undesirable chemicals.

As used herein, the term “produced water” shall refer to both water generated during an oil or gas production operation as well as a wastewater stream containing undesirable contaminants produced from a waste treatment process or an industrial water treatment process.

Coupling of sonic energy and electrocoagulation reduces the retention time compared to the treatment method which uses only electrocoagulation. In fact, for a given quantity of produced water of identical composition, the retention time for the sample treated by the combination of electrocoagulation and sonic energy is less than that treated solely by electrocoagulation. Typically, for a sample of produced water, the retention time for the sample treated by the combination of electrocoagulation and sonic energy is at least 30% less than that treated solely by electrocoagulation (where the chemical constituency of the sample, the volume of the sample treated and the time duration of treatment is the same). Thus, a significant increase in efficiency results when electrocoagulation is coupled with sonic energy.

In addition to decreasing retention time, the coupling of electrocoagulation and sonic energy eliminates the need for or reduces the amount of chemical additives required to flocculate the contaminants and degradation products from produced water. In addition to eliminating or reducing the need for coagulants and/or flocculating agents, the method described herein reduces or eliminates the use of biocides. Typically, the presence of biocides is required in the treatment of produced water.

Thus, for a sample of produced water, the requisite amount of coagulants or flocculating agents to effectuate flocculation within a sample when coupling electrocoagulation and sonic energy is less than that required to effectuate flocculation within a sample using only electrocoagulation (where the chemical constituency of the sample, the volume of the sample treated and the time duration of treatment is the same).

In addition, it has been found that the use of ultrasonic waves mitigates and/or reduces the tendencies of scaling of contaminants on the electrode. This enhances the operational lifetime of the electrodes and the electrocoagulation device and thus reduces costs to operators.

In an embodiment, a flocculating reagent, such as aluminum hydroxide, a polyacrylamide, a partially hydrolyzed polyacrylamide or a quaternary ammonium compound like tetramethylammonium bromide, may be added to the electrocoagulation device or cell.

The electrocoagulation device may be any electrocoagulation device commercially available.

For instance, the electrocoagulation device used in the method described herein may include a housing, an electrocoagulation reaction chamber within the housing, and oppositely charged electrodes within the reaction chamber, typically consisting of a plurality of spaced oriented reaction plates/blades, most typically extending substantially vertical within the reaction chamber. The plurality of reaction plates are typically spaced apart from one another to create gaps which extend between adjacent reaction plates.

The housing may be of any shape and is typically designed to facilitate the application of the electric field to the produced water as it flows through the reactor. The housing may have an upper portion and a lower portion, the upper portion defining a development chamber and the lower portion defining the reaction chamber. Representative constructions of the electrocoagulation device may be those described in U.S. Pat. Nos. 6,139,710 and 6,488,835, incorporated by reference herein.

The electrocoagulation device has an inlet port to allow the desired flow of liquid into the reaction chamber and into the gaps or spaces between the blades or plates. An outlet port may also be provided, typically at a higher elevation, and downstream of the inlet port for allowing treated water to flow from the chamber.

The flow of produced water is in a flow direction upward through the gaps between the plurality of reaction plates. In such instances, the outlet may be positioned at the higher level above the inlet.

At least two reaction plate tabs are preferably integral with selected ones of the plurality of reaction plates, the reaction plate tabs having ends that may be isolated from the flow of liquid in the housing.

A source of power provides line voltage to the tabs in order to create an electrical field for the treatment within the reaction chamber. The electric field may be generated from essentially any suitable direct current (DC) or alternating current (AC) source.

In a preferred embodiment, a direct current electric field is used. An electrical potential between the anode and cathode in the electrochemical reactor can be between about 1.5 volts and 12 volts with successful results, however much higher voltages can also be used as desired. The electrical potential is measured in the gaps between the reaction plates.

The anode may be of any material that allows the flow of electrons including, but not limited to metals such as copper, silver, gold, magnesium zinc, aluminum, iron, nickel tin; non-metals or combinations thereof (e.g., alloys or coated or multi-layered structures), such as carbon-based materials like graphite; or combinations of metals and non-metals. The metal may be galvanized or formed in combination with oxygen or oxides. In a preferred embodiment, the anode is made of a copper alloy.

The cathode may be made of any materials to which positively charged ions migrate when the electric current is passed, including copper alloys, stainless steel, platinum, nickel or iron or alloys thereof.

Selected blades may connect to electrical leads which carry an input line voltage. An electrical field is created in the chamber between the electrically connected blades. The electrical leads may be attached to selected blades in order to provide the reaction chamber with the desired voltage and amperage to optimize electrocoagulation of the produced fluid. The ability to vary voltage and amperage within the electrical field of the chamber may be achieved without the use of a separate transformer.

A pump may be placed upstream of the inlet in order to provide additional head for the flow of liquid passing through the apparatus. A series of pre-filters or other preconditioning means may be placed in line with the pump and also upstream of the inlet in order to remove solids or other materials which may otherwise clog the reaction chamber.

A control unit may be used to rectify the incoming AC line voltage to a DC voltage. Electrical leads may interconnect the blades to the DC voltage made available by the control unit. In addition to rectifying the incoming line voltage, the control unit may incorporate a number of other functions which helps to control the apparatus, such as a means to control the speed of the pump and a voltmeter and ammeter to monitor the conditions within the chamber. However, the control unit does not need a transformer as the electrical connections made with the blades may allow the desired voltage and amperage therein to be adjusted, as further discussed below. Additionally, the control unit can be in the form of a programmable logic controller which may only monitor status condition inputs, but also produce outputs to control the electrocoagulation process. For example, the voltage polarity of the electrical leads extending from the control unit may be reversed based upon a timing sequence controlled by the controller. As a further example, the control unit may measure the flow rate of the produced water and adjust it accordingly by either manipulating the pump speed or adjusting the flow rate through a valve positioned upstream of the inlet.

The reactor may further include other equipment to control the flow of reactants and products to and from the reactor. Preferably, the direction of the fluid flow is from the anode to the cathode.

The electro-sonication device which is coupled with the electrocoagulation device is capable of generating ultrasonic sound waves in liquids. Acceptable ultrasonic devices are commercially available. Typically, such devices consist of an ultrasonic generator and an ultrasonic transducer. The transducer, used for converting electrical energy into sound, is preferably a piezoelectric transducer. Any piezoelectric material suitable for converting electrical oscillations into mechanical vibrations are acceptable and include metals, such as barium titanate and lead zirconate titanate, and quartz. The transducer is typically 165 grade.

In an embodiment, an ultrasonic horn transducer or probe may be used. Ultrasound may then be directly delivered to the water stream using a metal horn tip. The horn will act as an amplifier with the shape of the tip determining the mechanical amplification of the piezoelectric vibration. Typically, the tip will have a length corresponding to a multiple of half wavelengths of the ultrasonic wave. The horn is preferably composed of a titanium alloy. Typically, the horn is placed in the container housing the sonic energy device at a depth of not less than 1 to 2 cm.

A cooling coil may further be connected to a thermostat and introduced into the container housing the sonic energy device in order to reduce the amount of heat which typically evolves from high intensity ultrasound.

In a preferred embodiment, ultrasound waves generated from the electro-sonication device causes the formation of micro bubbles which only collapse at the molecular level at extremely high temperatures and pressures. Thus, chemical reactions, such as oxidation, may occur with minimal effect at ambient temperatures.

The formation of the microbubbles occurs more readily in the vicinity of the electrode surface of the electrocoagulation device compared to that in the bulk solution due to typically weaker molecular interactions of the organic molecules in the produced water and wastewater. Upon collapse of the microbubbles, electrolyte is typically cast against the electrode surface. This brings new electroactive material giving an enhanced current to the electrocoagulation device. If the vapor pressure is low within the cell, the microbubbles may grow smaller which may cause an increase in frequency in collapse of the microbubbles. It is preferred that the microbubbles be small at low vapor pressure in order to minimize the likelihood of escape from the surface.

The frequency of the ultrasound waves to which the wastewater is subjected is greater than 16 kHz and is typically from 16 kHz to 500 MHz.

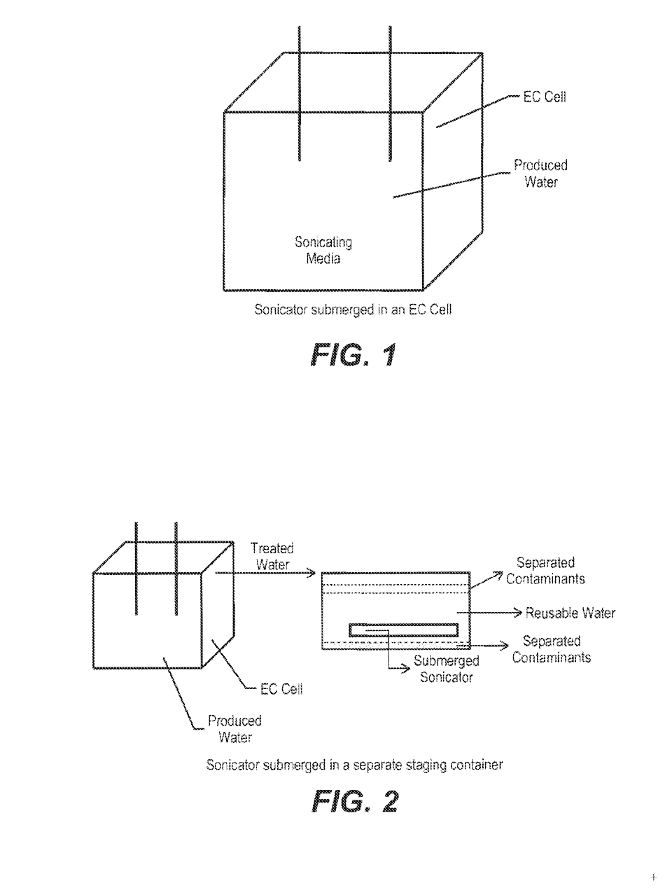

In the embodiment illustrated in FIG. 1, a sonicating media is submerged into the electrocoagulation cell in order to generate and transmit ultrasonic waves. This arrangement reduces the scaling onto the electrode. Reducing fouling of the electrodes reduces cell maintenance and enhances commercial success of the operation. As the ultrasonic waves are generated in the cell, they carry flocculants upwards faster in the cell. The use of ultrasound waves increases the rate of mass transport of the undesired chemicals of the produced water to the surface of the cell, thereby reducing retention time. Thus, the embodiment referenced in FIG. 1 reduces not only the operational footprint of the process but further saves costs and operational time.

In one embodiment, one or more transducers may be placed beneath the electrocoagulation cell and be separated from the electrocoagulation cell by a physical barrier.

In an embodiment, the electrocoagulation device may be separated from the sonication device such that after the produced water has been subjected to electrocoagulation, the treated water is then transferred into a separate container for sonication. The separate container may be a water storage chamber or a frac tank. The reclaimed or reusable water then exits from the separate tank or chamber without flocculated contaminants. This embodiment may be illustrated by FIG. 2, wherein produced water may first be flocculated in the electrocoagulation cell as the treated water rapidly flows through the cell. During sonication in the second chamber, flocculated contaminants are separated from reusable water in a light or upper phase and/or a heavy or lower phase. Water exiting from the second chamber may then be reused in a subsequent treatment operation. The use of the separate staging container represented by FIG. 2 dramatically reduces the retention time for settling of the flocculated materials. The staging container of FIG. 2 may be used specifically for the purpose of settling and floating of the undesirable contaminants.

The method described herein is highly efficient with flocculating aromatic compounds. Such compounds may be oxidized/destroyed by the described sonoelectrochemical procedure at low acoustic wave frequencies. Such compounds agglomerate and the agglomerates become larger as the amount of sonic energy is applied. During the process, free radicals are formed. In the absence of reactive organic compounds with the free radicals, the formation of hydroxyl free radicals from water may be followed by recombination processes that lead to the formation of hydrogen peroxide. The hydrogen peroxide may also be used as a breaker in the destruction of organic polymers present in the production water or wastewater stream.

Waste generated by the combination of electrocoagulation and sonic energy may be readily settable and may be easily dewatered or filtered. Filtration may be carried out by centrifugal mechanical such as use of a filter mesh in a rotary chamber to produce a filtered water stream and a waste filtrate stream. The filtered water stream may then be passed to a media filtration tank capable of collection, filtration and back flushing of post treatment residual and coagulated solids. The filtered water from the media filtration tank may further be passed to a filter mechanical to provide a filtered water discharge having entrained solids level which meets acceptable standards.

Typically, the particle size of the generated flocculants is larger than flocculants generated from electrocoagulation solely.

Further, the tendency of electrode scaling is dramatically reduced by use of the combination of electrocoagulation and sonic energy (versus electrocoagulation solely). Further, scales and minerals are more easily removed from electrode surfaces or plates of the electrocoagulation cell when sonication is coupled with electrocoagulation. As such, the operational lifetime of the electrodes in the electrocoagulation cell is enhanced which results in reduced costs to operators.

Other embodiments within the scope of the claims herein will be apparent to one skilled in the art from consideration of the description set forth herein. It will be observed that numerous variations and modifications may be effected without departing from the true spirit and scope of the novel concepts of the invention.

What is claimed is:

1. A method of removing undesirable contaminants from produced water comprising:
(a) introducing produced water into an electrocoagulation device and inducing flocculation of contaminants present in the produced water within the electrocoagulation device;
(b) subjecting the treated water of step (a) to sonic energy; and
(c) collecting reclaimed water without flocculated contaminants from the treated water subjected to sonic energy.

2. The method of claim 1, further comprising, prior to step (c), oxidizing and/or destroying the contaminants with microbubbles generated from the ultrasonic waves of the source of the sonic energy.

3. The method of claim 1, wherein flocculation in step (a) occurs without the addition of a treatment additive to the produced water.

4. The method of claim 1, wherein flocculation in step (a) is aided by the addition of an additive to the produced water.

5. The method of claim 1, wherein the method is a continuous method.

6. The method of claim 1, wherein flocculation in step (a) occurs in the absence of a coagulant or flocculant.

7. The method of claim 1, wherein flocculation in step (a) occurs in the absence of a biocide.

8. The method of claim 1, wherein step (b) occurs in the electrocoagulation cell.

9. The method of claim 1, wherein the treated water of step (a) is subjected to sonic energy in a staging area outside the electrocoagulation cell.

10. The method of claim 1, wherein the flocculated contaminants are subjected to sonic energy by a source having a transducer composed of quartz or a metal.

11. The method of claim 10, wherein the transducer is composed of quartz, barium titanate or lead zirconate.

12. The method of claim 1, wherein the frequency of ultrasonic waves generated by the source of sonic energy to which the produced water is subjected in step (b) is between from about 16 kHz to about 500 MHz.

13. The method of claim 1, wherein the source of the sonic energy has an ultrasonic horn transducer or probe.

14. The method of claim 13, wherein the ultrasonic horn transducer or probe is submerged within the electrocoagulation cell.

15. The method of claim 1, wherein the produced water is generated during an oil or gas production operation.

16. A method of reducing the retention time in the formation of flocculants of contaminants during treatment of produced water comprising:
(a) introducing the produced water into an electrocoagulation device and inducing flocculation of the contaminants within the electrocoagulation device;
(b) subjecting the flocculated contaminants to ultrasonic waves; and
(c) separating the flocculated contaminants subjected to ultrasonic waves from the produced water.

17. The method of claim 15, wherein the produced water is generated during an oil or gas production operation.

18. The method of claim 16, further comprising, prior to step (c), oxidizing and/or destroying the contaminants with microbubbles generated from the ultrasonic waves.

19. The method of claim 16, wherein the product of step (b) is separated from the produced water by filtration.

20. The method of claim 16, wherein flocculation in step (a) is induced in the absence of a treatment additive to the produced water.

21. The method of claim 16, wherein flocculation in step (a) is induced in the absence of a coagulant, flocculant and/or a biocide.

22. The method of claim 16, wherein the ultrasonic waves of step (b) are generated by a sonic energy source within the electrocoagulation cell.

23. The method of claim 22, wherein the transducer of the sonic energy source is separated from the electrocoagulation cell by a barrier.

24. The method of claim 16, wherein the frequency of the ultrasound waves to which the produced water is subjected is between from 16 kHz to 500 MHz.

25. The method of claim 22, wherein the sonic energy source has a horn transducer or probe submerged within the electrocoagulation cell.

26. The method of claim 16, wherein the ultrasonic waves are generated in a sonic energy source in a staging area outside the electrocoagulation cell.

27. A method of preventing or reducing the formation of scales on the electrode of an electrocoagulation cell during the formation of flocculants of contaminants from produced water generated during an oil and gas production operation comprising:
(a) introducing the produced water into an electrocoagulation cell and inducing flocculation of the contaminants within the electrocoagulation cell;
(b) subjecting the flocculating contaminants to ultrasonic waves generated from a sonic energy source within the electrocoagulation cell; and
(c) collecting reclaimed water, from which flocculated contaminants have been removed, from the electrocoagulation cell
wherein the amount of scales formed on the electrode of the electrocoagulation cell is less than the amount of scales formed when a sonic energy source is not included within the electrocoagulation cell.

28. The method of claim 27, wherein the reclaimed water is collected in step (c) by filtration.

29. A method of removing contaminants from produced water from an oil or gas treatment operation comprising:
(a) introducing the produced water into an electrocoagulation cell and inducing flocculation of the contaminants within the electrocoagulation cell;
(b) feeding the product of step (a) to a separate container containing a sonic energy source and subjecting the product to ultrasonic waves within the separate container; and
(c) collecting reclaimed water from the produced water subjected to ultrasonic waves, wherein flocculated contaminants have been removed from the reclaimed water.

30. The method of claim 29, further comprising, prior to step (c), oxidizing and/or destroying the contaminants with microbubbles generated from the ultrasonic waves.

31. The method of claim 29, wherein the flocculation of step (a) is induced in the absence of a well treatment additive.

32. The method of claim 29, wherein flocculation of step (a) is induced in the absence of a coagulant and/or biocide.

33. The method of claim 29, wherein the frequency of the ultrasound waves to which the product of step (a) is subjected is between from about 16 kHz to about 500 MHz.
